(19) United States
(12) Patent Application Publication
(10) Pub. No.: US 2023/0169141 A1
(43) Pub. Date: Jun. 1, 2023

(54) SURROGATE BINARY OPTIMIZATION

(71) Applicant: FUJITSU LIMITED, Kawasaki-shi, Kanagawa (JP)

(72) Inventors: Hirotaka TAMURA, Kawasaki-shi (JP); Mehrdad MALEKMOHAMMADI, Toronto (CA); Keivan DABIRI, Toronto (CA); Ali SHEIKHOLESLAMI, Toronto (CA)

(73) Assignees: FUJITSU LIMITED, Kawasaki-shi, Kanagawa (JP); THE GOVERNING COUNCIL OF THE UNIVERSITY OF TORONTO, Toronto, ON (CA)

(21) Appl. No.: 17/922,558

(22) PCT Filed: Apr. 30, 2021
(86) PCT No.: PCT/US2021/030307

§ 371 Date: Oct. 31, 2022

Related U.S. Application Data
(60) Provisional application No. 63/019,046, filed on May 1, 2020.

(51) Int. Cl. G06F 17/11

(52) U.S. Cl. CPC G06F 17/11

(57) ABSTRACT

Operations may include identifying variables corresponding to an optimization problem, each variable having an initial value. The operations may include calculating an objective function value based on the initial value of each variable and a plurality of function value changes. Each function value change may be calculated based on a different variable value change, each variable value change corresponding to a respective change made to a different one of the variables. The operations may include selecting a subset of the variables based on the respective function value changes and corresponding variable value changes made to the respective initial values of the variables of the subset and generating a surrogate quadratic unconstrained binary optimization (QUBO) model using the subset. The operations may include determining a solution to the optimization problem including a set of solution values using the surrogate QUBO model, each of the solution values corresponding to a different variable.

### CROSS-REFERENCE TO RELATED APPLICATIONS

This application claims priority to U.S. Provisional Application No. 63/019,046, filed May 1, 2020, which is incorporated by reference herein in its entirety.

### BACKGROUND

The present disclosure generally relates to surrogate binary optimization.

An optimization problem may be solved by finding an input value that returns a maximum value or a minimum value for a function that represents the optimization problem. Solving the problem may be achieved in polynomial time as defined by a time-complexity polynomial equation. Optimization problems that may not be solved in polynomial time may be classified as non-deterministic polynomial acceptable problems, or NP-hard problems. Solving an NP-hard problem may be difficult because the time required to determine an effective solution to the NP-hard problem may increase exponentially depending on the number of variables that must be optimized to solve the optimization problem.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, operations may include identifying a plurality of variables corresponding to an optimization problem, each variable of the plurality of variables having a corresponding initial value. The operations may include calculating an objective function value based on the initial values of the plurality of variables. The operations may include calculating a plurality of function value changes of the objective function value, wherein each of the plurality of function value changes is calculated based on a different one of a plurality of variable value changes and each of the variable value changes corresponds to a respective change made to a different one of the initial values. The operations may include selecting a subset of the variables based on the respective function value changes that correspond to corresponding variable value changes made to the respective initial values of the variables of the subset of variables. The operations may include generating a surrogate quadratic unconstrained binary optimization (QUBO) model of the optimization problem using the selected subset of variables. The operations may include determining one or more candidate solutions to the optimization problem using the surrogate QUBO model, each of the one or more candidate solutions comprising a set of solution values corresponding to the plurality of variables and each of the solution values of the set of solution values corresponding to a different variable of the plurality of variables. The operations may include determining a solution to the optimization problem based on the one or more candidate solutions.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a diagram representing an example system related to determining a solution to a binary optimization problem.

FIG. 2 is a flowchart of an example method of determining the solution to the binary optimization problem.

FIG. 3 is a diagram representing a variable associated with the binary optimization problem and binary nodes corresponding to the variable.

FIG. 4 is a flowchart of an example method of iteratively updating values of variables associated with the binary optimization problem to determine the solution to the binary optimization problem.

FIG. 5 is a flowchart of an example method of selecting a solution to the binary optimization problem based on one or more candidate solutions using an incremental update scheme.

FIG. 6 is a diagram of an example embodiment implementing the incremental update scheme.

FIG. 7 is an example system that may be used to determining the solution to the binary optimization problem.

### DETAILED DESCRIPTION

Some NP-hard problems may be approximated such that the approximated NP-hard problem may be solved more efficiently. One such method of approximating NP-hard problems is approximating input variables to the optimization problem with binary nodes. Optimization of the binary nodes via binary optimization may yield solutions to the overarching NP-hard problems. A widely studied binary optimization model is a quadratic unconstrained binary optimization (QUBO) problem, which may be solved by current methods such as a quantum annealer approach. However, current methods of solving QUBO problems and other binary optimization problems may only accommodate a small number of input variables and/or may require a large amount of time and computing resources to solve the binary optimization problem as the number of variables increases.

Combinatorial optimization problems are a subset of mathematical optimization problems in which the goal of optimization is to determine one or more maxima or minima of an objective function given one or more input-variable constraints. Combinatorial optimization problems often present a relatively large number of input variables such that traditional brute-force techniques to determine useful solutions to the problem may be prohibitively limiting. Common examples of combinatorial optimization problems include the travelling salesperson problem and the knapsack problem.

The embodiments described in the present disclosure may relate to determining a solution to a combinatorial optimization problem. Some embodiments described in the present disclosure may relate to determining a solution to a combinatorial optimization problem by approximating the combinatorial optimization problem as a binary optimization problem. For example, as discussed in further detail below, a subset of variables of a combinatorial optimization problem may be selected for use as a QUBO model that may operate as a surrogate QUBO model of the entire combinatorial optimization problem. One or more candidate solutions to the optimization problem may be determined by the QUBO model, and a solution to the optimization problem may be determined based on the one or more candidate solutions. For example, verifying the quality of a candidate solution may include comparing the candidate solution to the one or more given input-variable constraints of the combinatorial optimization problem.

The selection of the subset of variables as disclosed in further detail below may allow for the solving of combinatorial optimization problems using the surrogate QUBO model that otherwise may not have been solved using QUBO modeling. Using surrogate QUBO modeling as disclosed in the present disclosure to solve combinatorial optimization problems may improve the speed of computing systems in accurately solving combinatorial optimization problems. By contrast, some current techniques of solving combinatorial optimization problems may solve the problem quickly but may be more prone to converging at inaccurate results because the solutions determined by such optimization methods may be more likely to converge at local maxima or minima. Further, other techniques of solving combinatorial optimization problems that may provide higher quality results may take a prohibitive amount of time as compared to using surrogate QUBO modeling as disclosed in the present disclosure. Additionally or alternatively, using surrogate QUBO modeling as disclosed in the present disclosure may decrease the number of computing resources used by computing systems that may solve combinatorial optimization problems. Accordingly, the embodiments of the present disclosure help improve the efficiency of computing systems configured to solve combinatorial optimization problems.

Embodiments of the present disclosure are explained with reference to the accompanying figures.

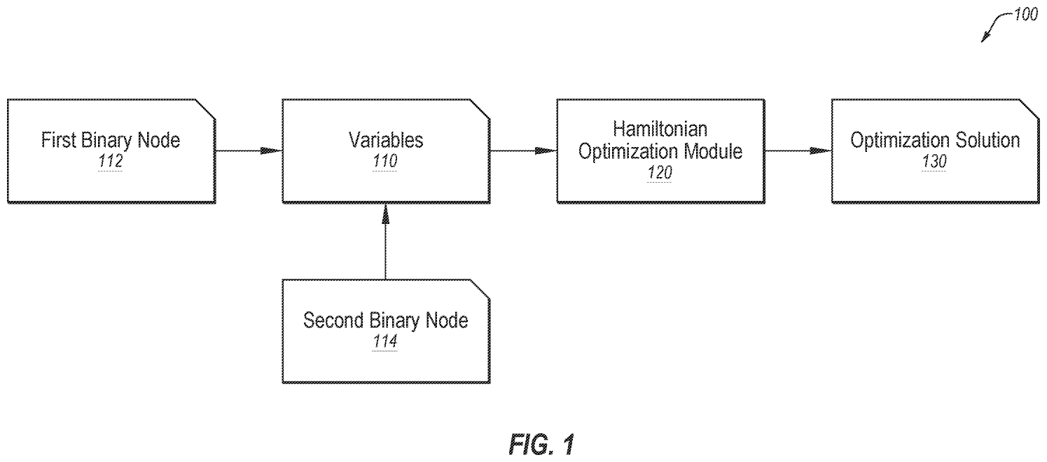

FIG. 1 is a diagram of an example system 100 related to determining a solution to a binary optimization problem, in accordance with one or more embodiments of the present disclosure. The system 100 may include variables 110, a Hamiltonian optimization module 120, and an optimization solution 130.

The variables 110 may include any input variables related to an optimization problem that may be modified by the Hamiltonian optimization module 120 in determining one or more candidate solutions to the combinatorial optimization problem. The Hamiltonian optimization module 120 may obtain a subset of the variables 110 for use as a surrogate QUBO model, and one or more candidate solutions to the surrogate QUBO model may represent potential solutions to the combinatorial optimization problem including all of the variables 110.

Each of the variables 110 may include a corresponding value. A solution to the optimization problem may include a subset of the variables 110 such that the value corresponding to each of the variables in the set may be used to assess a quality of the solution to the optimization problem. For example, a particular optimization problem may be a resource-allocation problem such as the knapsack problem. In this particular example, a knapsack with a maximum weight capacity may hold one or more objects, each of the one or more objects assigned a weight and a value. The one or more objects may represent the one or more variables 110, and a solution to the knapsack problem may be represented by a set of objects that may be held in the knapsack based on the weight of each object and the maximum weight of the knapsack. The quality of the solution to the knapsack problem may be calculated based on the value assigned to each of the one or more objects included in the set.

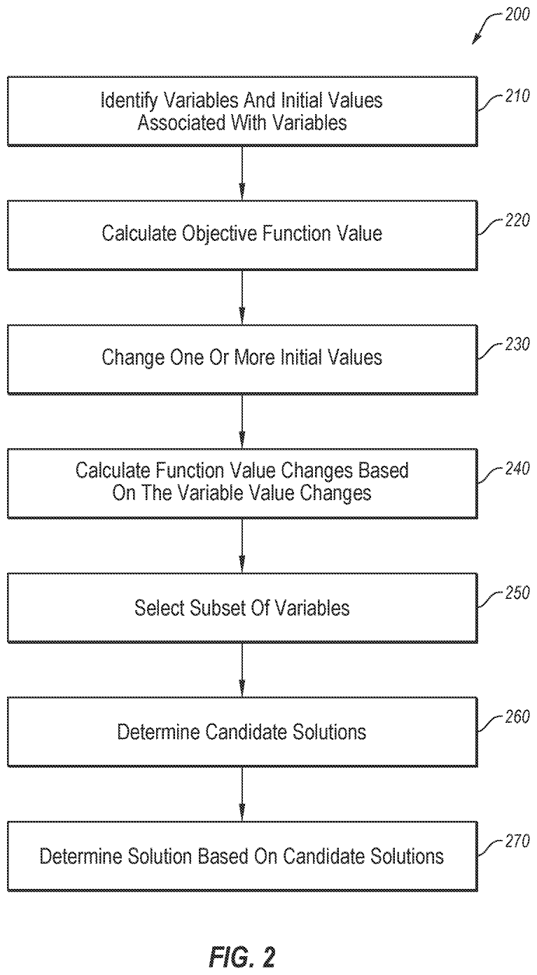

An objective function value may be calculated based on each of the one or more variables 110. The objective function may be a quantitative representation of the parameter to be maximized or minimized to solve the optimization problem. In some embodiments, the objective function may be a cost to be minimized, such as the travel distance in the traveling salesperson problem discussed in further detail below in relation to FIG. 2. In some embodiments, the objective function may be a value to be maximized, such as a summation of the values assigned to each object in the knapsack problem discussed above.

Changing one or more values corresponding to the variables 110 may facilitate a change in the objective function value. One or more variables 110 may be selected as a subset of the variables 110 for use as the surrogate QUBO model. The subset of the variables 110 may be selected based on an influence of each variable with respect to solving the combinatorial optimization problem. In some instances, the influence of a particular variable with respect to solving the combinatorial optimization problem may be related to a degree in which a change made to the value of the particular variable changes the objective function value. For example, the more a variable value change of the particular variable changes the objective function value, the more influence the particular variable may have on solving the combinatorial optimization function. As such, in some embodiments, an influence of a particular variable of the one or more variables 110 on the objective function value may be determined based on the variable value change corresponding to the particular variable and the function value changes associated with the variable value change.

In some embodiments, the variable value changes corresponding to the one or more variables 110 may be modified by one or more binary nodes, each of the one or more binary nodes including a corresponding binary value. In these and other embodiments, the value corresponding to each of the one or more variables 110 may be modified by one binary node such that each of the one or more variables 110 may take one of two values. For example, a particular variable modified by one binary node may take a first value corresponding to a first binary value of the binary node or a second value corresponding to a second binary value of the binary node. The particular variable may take the first value responsive to the binary value of the binary node being 0, and the particular variable may take the second value responsive to the binary value of the binary node being 1.

In some embodiments, the value corresponding to each of the variables 110 may be modified by two binary nodes. In these and other embodiments, each of the variables 110 may have an initial value and be assigned a first binary node 112 and a second binary node 114. The first binary node 112 and the second binary node 114 may indicate changes to the initial value of each of the variables 110. For example, the first binary node assigned to the particular variable may indicate an increase in the initial value of the particular variable by a predetermined interval. The second binary node assigned to the particular variable may indicate a decrease in the initial value of the particular variable by the predetermined interval. In some embodiments, the value corresponding to each of the variables 110 may be modified by more than two binary nodes such that each binary node assigned to a particular variable modifies the particular variable in some capacity. For example, a particular variable may be assigned a first binary node, a second binary node, a third binary node, and a fourth binary node. The first binary node may indicate an increase in the initial value of the particular variable by a first interval, and the second binary node may indicate a decrease in the initial value of the particular variable by the first interval. The third binary node may indicate an increase in the initial value of the particular variable by a second interval, and the fourth binary node may indicate a decrease in the initial value of the particular variable by the second interval.

The Hamiltonian optimization module 120 may include code and routines configured to enable a computing system to perform one or more operations. Additionally or alternatively, the data augmenter may be implemented using hardware including a processor, a microprocessor (e.g., to perform or control performance of one or more operations), a field-programmable gate array (FPGA), or an application-specific integrated circuit (ASIC). In some other instances, the Hamiltonian optimization module 120 may be implemented using a combination of hardware and software. In the present disclosure, operations described as being performed by the Hamiltonian optimization module 120 may include operations that the Hamiltonian optimization module 120 may direct a corresponding system to perform. The Hamiltonian optimization module 120 may be configured to perform a series of operations with respect to the one or more variables 110 as described in further detail below in relation to at least methods 200, 300, or 500 of FIG. 2, 3, or 5, respectively.

In some embodiments, the Hamiltonian optimization module 120 may be configured to solve the surrogate QUBO model according to at least the example method described below in relation to FIG. 2. In some embodiments, the Hamiltonian optimization module 120 may be configured to output one or more candidate optimization solutions 130 based on the one or more variables 110 obtained by the Hamiltonian optimization module 120 as inputs to the surrogate QUBO model. Solving the surrogate QUBO model may result in one or more candidate solutions, such as the candidate optimization solutions 130. The one or more candidate optimization solutions 130 may be compared to constraints associated with the optimization problem to assess the quality of the candidate optimization solutions 130 and/or determine a solution to the combinatorial optimization problem based on the candidate optimization solutions 130. Selection of the subset of the variables 110 for the surrogate QUBO model, determining the one or more candidate solutions, and determining the solution to the combinatorial optimization problem are described in detail below in relation to FIG. 2.

Modifications, additions, or omissions may be made to the system 100 without departing from the scope of the disclosure. For example, the designations of different elements in the manner described is meant to help explain concepts described herein and is not limiting. For instance, in some embodiments, the variables 110, the Hamiltonian optimization module 120, and the candidate optimization solution 130 are delineated in the specific manner described to help with explaining concepts described herein but such delineation is not meant to be limiting. Further, the system 100 may include any number of other elements or may be implemented within other systems or contexts than those described.

FIG. 2 is a flowchart of an example method 200 of determining the solution to the binary optimization problem according to at least one embodiment of the present disclosure. The method 200 may be performed by any suitable system, apparatus, or device. For example, the Hamiltonian optimization module 120 may perform one or more of the operations associated with the method 200. Although illustrated with discrete blocks, the steps and operations associated with one or more of the blocks of the method 200 may be divided into additional blocks, combined into fewer blocks, or eliminated, depending on the particular implementation.

The method 200 may begin at block 210, where one or more variables may be identified. In some embodiments, identification of the one or more variables may be facilitated by a user who defines the optimization problem. The user may define the optimization problem by deciding optimization parameters and constraints associated with objective functions of candidate solutions. Based on the parameters and the constraints of the optimization problem, input variables related to the parameters and the constraints may be identified. For example, a traveling-salesperson problem may include optimization of a route on which a salesperson intends to travel. The user may determine a number of cities to which the salesperson will travel. Additionally or alternatively, the user may decide that a particular optimized route may be determined based on the route having the least amount of distance. In this particular example, the user determined an optimization parameter to be minimizing travel distance. The user may identify one or more particular variables related to the traveling-salesperson problem as including every possible pairing between each of the cities. The value corresponding to each of the identified variables may include the distance between the cities included in each city pairing.

At block 220, the objective function value may be calculated. The objective function value may be a value of an objective function calculated based on initial values associated with the one or more identified variables as described above in relation to FIG. 1.

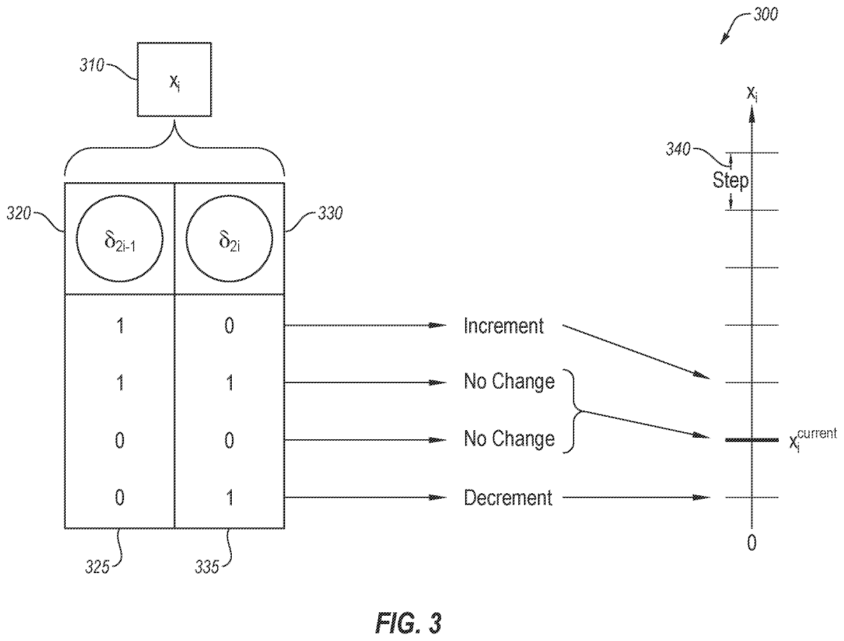

At block 230, an initial value associated with one or more of the variables may be changed. Each of the one or more variable value changes may affect a function value change. In some embodiments, each of the one or more variable value changes may include a same change made to a different one of the initial values associated with the one or more variables. Additionally or alternatively, the one or more variable value changes may include a different variable value change made to each of the initial values associated with the one or more variables. In these and other embodiments, the one or more variable value changes affecting the different variable value change made to each of the initial values associated with the one or more variables may include a same percentage change made to each of the one or more variables. In some embodiments, the one or more variable value changes may be determined using one or more binary nodes. In these and other embodiments, one or more binary nodes may be assigned to each of the one or more variables. Assignment of the one or more binary nodes to each variable and determining the variable value changes may occur as described in relation to FIGS. 1 and 3.

FIG. 3 illustrates an example of a particular variable and two particular binary nodes associated with the variable as a particular variable-node grouping 300, in accordance with one or more embodiments of the present disclosure. The variable-node grouping 300 may include a variable 310, a first binary node 320, and a second binary node 330. The variable 310 may correspond to a binary optimization problem and have an initial value as represented by xᵢ in FIG. 3. The first binary node 320 may represent an increment in the value of the variable 310 by a step 340 and have a first binary value 325 as represented by δ₂ᵢ₋₁ in FIG. 3. The first binary value 325 may be a value in {0, 1}. For example, a particular first binary value may take a value of 0. A second particular first binary value may take a value of 1. The second binary node 330 may represent a decrement in the value of the variable 310 by the step 340 and have a second binary value 335 as represented by δ₂ᵢ in FIG. 3. The second binary value 335 may be a value in {0, 1}. For example, a particular second binary value may take a value of 0. A second particular second binary value may take a value of 1.

Because the first binary value 325 and the second binary value 335 may each take one of two values in {0, 1}, a variable 310 including a first binary node 320 and a second binary node 330 may include one of four possible combinations of binary node values. A first combination may include a first binary node 320 with a first binary value 325 of 1 and a second binary node 330 with a second binary value 335 of 0. A particular variable having the first combination of binary node values may indicate an initial value corresponding to the particular variable will be incremented by a particular step, such as the step 340. A second combination may include a first binary node 320 with a first binary value 325 of 1 and a second binary node 330 with a second binary value 335 of 1. A particular variable having the second combination of binary node values may indicate an initial value corresponding to the particular variable will not be changed. A third combination may include a first binary node 320 with a first binary value 325 of 0 and a second binary node 330 with a second binary value 335 of 0. A particular variable having the third combination of binary node values may indicate an initial value corresponding to the particular variable will not be changed. A fourth combination may include a first binary node 320 with a first binary value 325 of 1 and a second binary node 330 with a second binary value 335 of 1. A particular variable having the fourth combination of binary node values may indicate an initial value corresponding to the particular variable will be decremented by a particular step, such as the step 340. For example, a particular variable may have an initial value of xᵢ, a first binary node with a first binary value of 1 and a second binary node with a second binary value of 0. A particular step associated with the particular variable may be s. The initial value corresponding to the particular variable may be incremented such that a value of the particular variable is xᵢ+s.

In some embodiments, the variable value changes may be calculated by flipping binary values associated with one or more binary nodes corresponding to the one or more variables. In some embodiments, where one binary node is assigned to each variable, each of the binary nodes assigned to each variable may be flipped. Additionally or alternatively, only one of the binary nodes assigned to one variable may be flipped. In some embodiments, where a first binary node and a second binary node are assigned to each variable, each of the first binary nodes assigned to each variable may be flipped while each of the second binary nodes are not flipped. Additionally or alternatively, each of the second binary nodes assigned to each variable may be flipped while each of the first binary nodes are not flipped.

Returning to FIG. 2 at block 240, one or more function value changes may be calculated based on the variable value changes. In some embodiments, the objective function value may be recalculated based on the variable value changes to determine the one or more function value changes. In these and other embodiments, the one or more function value changes may be calculated based on the recalculated objective function value and the objective function value.

For example, an objective function value may be calculated based on a given first variable, a given second variable, and a given third variable. An influence of the given first variable on the objective function value may be determined by changing a value of the given first variable by a first variable value change. The objective function value may be recalculated based on the changed value of the given first variable (which is changed according to the first variable value change), the given second variable, and the given third variable to determine a first updated objective function value. A first function value change may be calculated based on the first updated objective function value and the objective function value (e.g., based on the difference between the first updated objective function value and the objective function value). Similarly, an influence of the given second variable on the objective function value may be determined by reverting the given first variable to its previous value and changing a value of the given second variable by a second variable value change. The objective function value may be recalculated based on the given first variable, the changed value of the given second variable (which is changed according to the second variable value change), and the given third variable to determine a second updated objective function value. A second function value change may be calculated based on the second updated objective function value and the objective function value.

At block 250, a subset of the variables may be selected for optimization. Selection of the subset of the variables may depend on the objective function value, the function value changes, and/or the variable value changes. In some embodiments, the variables may be sorted according to the function value change corresponding to the variable value change associated with each variable. For example, a variable value change indicating a change only in an initial value of a first variable may affect a first function value change, and a variable value change indicating a change only in an initial value of a second variable may affect a second function value change. In these and other embodiments, the variables may be sorted from a greatest function value change to a lowest function value change. In these and other embodiments, the variables associated with the lowest function value changes may be selected as the subset for optimization. In some embodiments, the number of variables included in the subset for optimization may be determined by a user and/or according to ranking rules. For example, a user may determine that a particular number of variables to be selected is an absolute number of variables, a percentage of the total number of variables, or any variables having a function value change equal to, greater than, or less than a predetermined function value change threshold.

At block 260, one or more candidate solutions to the binary optimization problem may be determined based on the selected subset of variables. Each candidate solution may include a set of solution values in which each solution value corresponds to a value associated with a different variable of the binary optimization problem. The candidate solutions to the binary optimization problem may be determined by fixing the value of each variable not included in the subset of variables selected at block 250 such that the values do not change during the optimization process and modeling the selected subset of variables as a surrogate quadratic unconstrained binary (QUBO) problem.

In some embodiments, solving the QUBO problem may include minimizing the quadratic pseudo-boolean function, ƒ(δ₁, δ₂, . . . , δₙ), illustrated below may provide one or more candidate solutions to the surrogate QUBO model:

$$f ( {δ}_{1} , {δ}_{2} , … , {δ}_{n} ) = - {\sum }_{i < j} {W}_{i j} {δ}_{i} {δ}_{j} - {\sum }_{i} {b}_{i} {δ}_{i}$$

In the quadratic pseudo-Boolean function above, δᵢ may represent a binary variable taking values in {0, 1}. Wᵢⱼ may represent a connection strength between variables δᵢ and δⱼ, and bᵢ may be a bias term for the δᵢ variable. Additionally or alternatively, solving the QUBO problem may include maximizing the quadratic pseudo-boolean function by flipping the signs of the connection strength Wᵢⱼ and the bias term bᵢ, as illustrated below:

$$f ( {δ}_{1} , {δ}_{2} , … , {δ}_{n} ) = {\sum }_{i < j} {W}_{i j} {δ}_{i} {δ}_{j} + {\sum }_{i} {b}_{i} {δ}_{i}$$

The surrogate QUBO model may be a model including the selected subset of variables and variables in an immediate neighborhood of the selected subset of variables. The immediate neighborhood of the selected subset of variables may include variables within a hamming distance of two bits or less from the selected subset of variables. The hamming distance between two particular variables may be calculated by representing each of the two particular variables as a string of bits and determining a number of differing bits between the two strings of bits.

Solving the surrogate QUBO model may be facilitated by using a Markov chain Monte Carlo (MCMC) search. The MCMC search may include representing the quadratic pseudo-Boolean function as a Markov chain and performing stochastic sampling of the quadratic pseudo-Boolean function until one or more minima corresponding to the pseudo-Boolean function are determined. While current methods of solving optimization problems may be prone to converging at non-optimal solutions due to existence of local minima or local maxima, the MCMC search may escape potential local minima or maxima because the stochastic sampling of the MCMC search may prevent convergence issues from occurring.

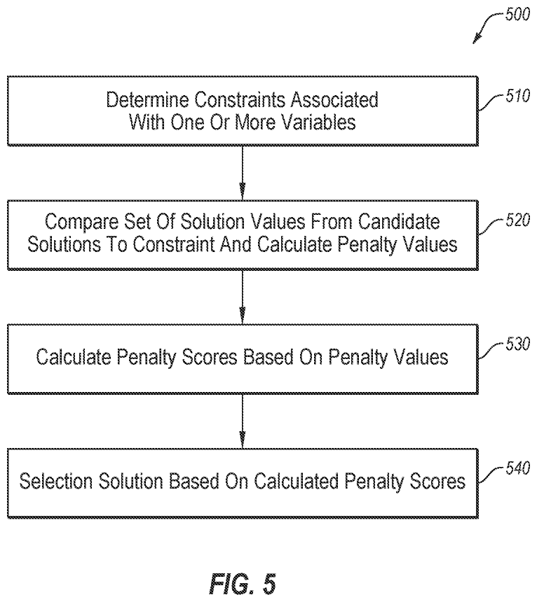

At block 270, a solution to the binary optimization problem may be determined based on the one or more candidate solutions. The solution to the binary optimization problem may be selected from the one or more candidate solutions based on how well each of the one or more candidate solutions satisfies constraints imposed on the optimization problem. In some embodiments, a penalty value may be assigned to each of the variables included in a particular candidate solution depending on how well each of the variables satisfies constraints of the optimization problem. Additionally or alternatively, a penalty score may be calculated based on the penalty value assigned to each of the variables, and the solution to the binary optimization problem may be determined based the penalty score. Determining the solution to the binary optimization problem based on penalty values and/or penalty scores associated with each of the one or more candidate solutions may be accomplished as described in further detail below in relation to FIG. 5.

Modifications, additions, or omissions may be made to the method 200 without departing from the scope of the disclosure. For example, the designations of different elements in the manner described is meant to help explain concepts described herein and is not limiting. Further, the method 200 may include any number of other elements or may be implemented within other systems or contexts than those described.

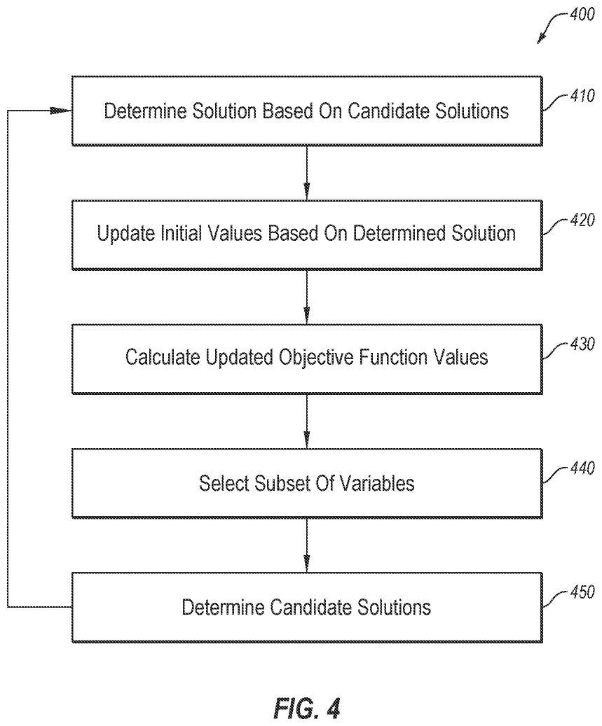

FIG. 4 is a flowchart of an example method 400 of iteratively updating values of variables associated with the binary optimization problem to determine the solution to the binary optimization problem, in accordance with one or more embodiments of the present disclosure. The method 400 may be performed by any suitable system, apparatus, or device. For example, the system 100 including the Hamiltonian optimization module 120 may perform one or more of the operations associated with the method 400. Although illustrated with discrete blocks, the steps and operations associated with one or more of the blocks of the method 400 may be divided into additional blocks, combined into fewer blocks, or eliminated, depending on the particular implementation.

The method 400 may include an iterative method beginning at block 410, where a solution to a binary optimization problem may be determined based on one or more candidate solutions. In some embodiments, the method 400 may iterate for a specified amount of time and/or number of iterations. For example, the method 400 may iterate for ten minutes and/or the method 400 may iterate through ten loops. Additionally or alternatively, repetition of the method 400 may be based on a change in the initial values of the variables and/or the objective function value associated with the initial values of the variables. For example, repetition of the method 400 may continue until the objective function value changes by ten percent of its initial value.

At block 410, determining the solution to the binary optimization problem may be the same or a similar process as described in relation to determining the solution to the binary optimization problem at block 270 of method 200 in FIG. 2.

At block 420, the initial value of each variable may be updated based on the solution determined at block 410 to determine an updated initial value of each variable. In some embodiments, the solution to the binary optimization problem determined at block 410 may be improved. Because the solution to the binary optimization problem depends in part on the initial values of the variables associated with the binary optimization problem, updating the initial values using the determined solution may improve the quality of solutions output by the MCMC search. In some embodiments, the initial value of each variable may be updated by taking the values associated with each variable in the determined solution as the updated initial values of each variable. Additionally or alternatively, the initial value of each variable may be updated by taking the values associated with each variable in the determined solution and adjusting the initial value based on a predetermined weight associated with the value of each variable in the determined solution.

At block 430, the objective function value may be recalculated based on the updated initial value corresponding to each variable to determine an updated objective function value. Calculating the updated objective function value may be facilitated by the same or a similar process as described in relation to calculating the objective function value at block 220 of method 200 with the updated initial value corresponding to each variable replacing the initial value at block 220.

At block 440, an updated subset of the variables may be selected based on the updated objective function value. Selecting the updated subset of variables may be facilitated by the same or a similar process as described in relation to selecting the subset of variables at block 250 of method 200 in FIG. 2.

At block 450, one or more candidate solutions may be determined based on the updated subset of variables selected at block 440. Determining the one or more candidate solutions may be the same or a similar process as described in relation to determining the one or more candidate solutions at block 260 of method 200 in FIG. 2.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

FIG. 5 is a flowchart of an example method 500 of determining a solution to a binary optimization problem based on one or more candidate solutions to the binary optimization problem, in accordance with one or more embodiments of the present disclosure. In some embodiments, steps included in the method 500 may be performed as additional steps during the method 200. For example, the method 500 may be performed in conjunction with or as an alternative to determining a solution based on one or more candidate solutions at block 270. The method 500 may be performed by any suitable system, apparatus, or device. For example, the system 100 including the Hamiltonian optimization module 120 may perform one or more of the operations associated with the method 500. Although illustrated with discrete blocks, the steps and operations associated with one or more of the blocks of the method 500 may be divided into additional blocks, combined into fewer blocks, or eliminated, depending on the particular implementation.

The method 500 may begin at block 510, where one or more constraints associated with one or more of the variables may be determined. The one or more constraints may relate to properties of an optimization problem, the properties of the optimization problem being represented by the one or more variables of the binary optimization problem. The constraints may be predetermined limits to the one or more variables. In some embodiments, one or more of the constraints may be upper-limit constraints such that a particular variable having a value greater than a particular upper-limit constraint associated with the particular variable may be penalized. Additionally or alternatively, one or more of the constraints may be lower-limit constraints such that a particular variable having a value less than a particular lower-limit constraint associated with the particular variable may be penalized. Additionally or alternatively, one or more of the constraints may be equality constraints such that a particular variable having a value not equal to a particular equality constraint associated with the particular variable may be penalized. In these and other embodiments, a limit type and/or value corresponding to each of the one or more constraints may be determined based on target values relating to the properties of the optimization problem.

At block 520, the sets of solution values corresponding to each of the one or more candidate solutions may be compared to the constraints, and penalty values may be calculated based on the comparison. Each of the solution values of a particular set of solution values and/or each constraint may be associated with a different variable such that a penalty value may be calculated for each variable including a corresponding solution value and constraint. In some embodiments, the penalty value may be calculated based on a degree of difference between the solution value and the respective constraint. For example, a solution value relating to a particular variable may have a first value, while a constraint relating to the particular variable may specify the value of the particular variable should be equal to or greater than a second value such that the second value represents a threshold value. In such an example, the constraint may be considered a lower-limit constraint because a penalty value may be calculated responsive to a value of the particular variable being less than or equal to the second value. Additionally or alternatively, the constraint may include an upper-limit constraint in which the penalty value may be calculated responsive to the solution value corresponding to the upper-limit constraint being equal to or greater than a threshold value associated with the constraint. Additionally or alternatively, the constraint may include an equality constraint in which the penalty value may be calculated responsive to the solution value not equaling the equality constraint. In these and other embodiments, a penalty value may be calculated for each variable based on one or more constraints associated with each of the variables. For example, a particular variable of a particular candidate solution may include a first upper-limit constraint having a first threshold value and a second lower-limit constraint having a second threshold value. In this example, a penalty value may be calculated for the particular variable responsive to a solution value corresponding to the particular variable being greater than the first threshold value and/or less than the second threshold value.

At block 530, a penalty score may be calculated. The penalty score may be a numerical heuristic representing how well a particular candidate solution satisfies the constraints of the binary optimization problem. The penalty score may be calculated based on the penalty values determined at block 520. In some embodiments, the penalty score may be a squared sum of the one or more penalty values. In these and other embodiments, a particular penalty value associated with the penalty score may be weighted such that the particular penalty value has a greater or lesser influence in calculating the penalty score.

At block 540, a solution to the binary optimization problem may be selected from the one or more candidate solutions based on the penalty score associated with each of the one or more candidate solutions. In some embodiments, the candidate solution selected as the solution to the binary optimization problem may be the candidate solution with the lowest penalty score indicating the selected candidate solution includes a set of solution values closest to satisfying the constraints of the binary optimization problem relative to the other one or more candidate solutions. Additionally or alternatively, selection of the solution to the binary optimization problem may include selecting more than one candidate solutions. Selecting more than one candidate solutions may allow a user to decide which of the selected candidate solutions is a more appropriate solution to the binary optimization problem. In these and other embodiments, the one or more candidate solutions may be returned in a list ordered based on the penalty score associated with each of the candidate solutions such that a user may select one or more solutions to the binary optimization problem.

Modifications, additions, or omissions may be made to the method 500 without departing from the scope of the disclosure. For example, the designations of different elements in the manner described is meant to help explain concepts described herein and is not limiting. Further, the method 500 may include any number of other elements or may be implemented within other systems or contexts than those described.

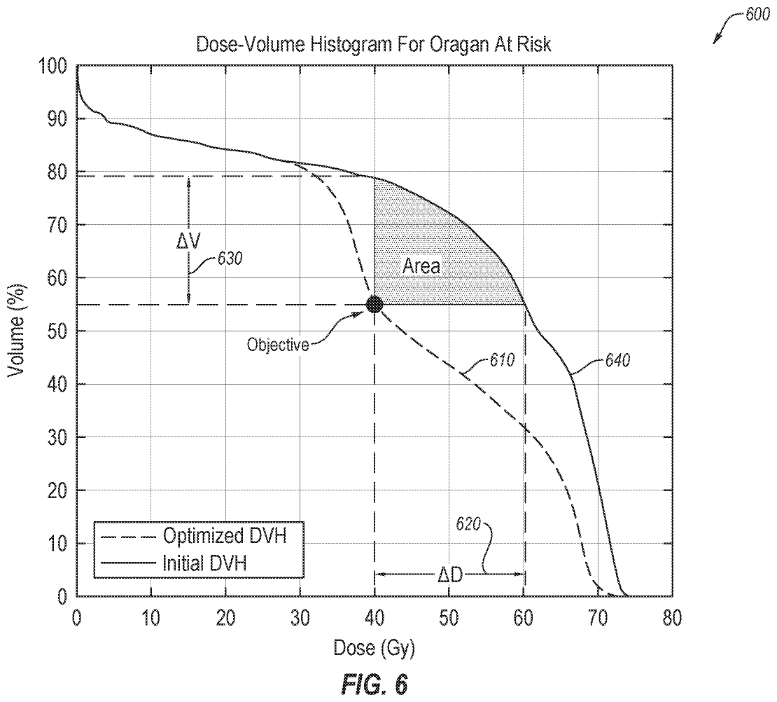

FIG. 6 illustrates an example graph 600 depicting a dose-volume histogram (DVH) representing a particular objective to a particular binary optimization problem relating to irradiation of a tumor and organs at risk for Intensity-Modulated Radiation Therapy. A penalty score may be calculated based on the graph 600 in accordance with methods and systems described in the present disclosure, such as the method 500.

The graph 600 may represent tissue volume as a function of radiation dosage. In some embodiments, the tissue volume may be quantified as a percentage of total tissue volume. In these and other embodiments, the radiation dosage may be quantified in units of gray (Gy). The graph 600 may include an initial DVH 610 for which a change in dosage 620 represented by ΔD is evaluated and/or adjusted based on a corresponding change in tissue volume 630 represented by ΔV. The change in dosage 620 may be calculated using a binary search method as described above in relation to the MCMC search method of FIG. 2. For example, the change in dosage 620 may be calculated by iteratively calculating the change in tissue volume 630 for a particular dosage and adjusting the particular dosage until the change in tissue volume 630 becomes zero. In some embodiments, the change in tissue volume 630 may be calculated based on a dose deposition matrix and a vector representing current radiation beam intensity values. The dose deposition matrix and the intensity vector may be multiplied to determine a total dosage received by each voxel of tissue represented as a dosage vector. The dosage vector may be compared to a vector representing dosage objective values and a number of voxels including larger dosages may be determined. Based on the change in dosage 620 and the change in tissue volume 630, an optimized DVH 640 may be determined.

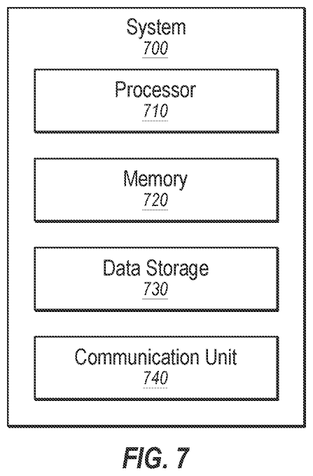

FIG. 7 illustrates an example computing system 700, according to at least one embodiment described in the present disclosure. The computing system 700 may include a processor 710, a memory 720, a data storage 730, and/or a communication unit 740, which all may be communicatively coupled. Any or all of the system 100 of FIG. 1 may be implemented as a computing system consistent with the computing system 700, including the variables 110, the first binary node 112, the second binary node 114, the Hamiltonian optimization module 120, and/or the optimization solution 130.

Generally, the processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 7, it is understood that the processor 710 may include any number of processors distributed across any number of network or physical locations that are configured to perform individually or collectively any number of operations described in the present disclosure. In some embodiments, the processor 710 may interpret and/or execute program instructions and/or process data stored in the memory 720, the data storage 730, or the memory 720 and the data storage 730. In some embodiments, the processor 710 may fetch program instructions from the data storage 730 and load the program instructions into the memory 720.

After the program instructions are loaded into the memory 720, the processor 710 may execute the program instructions, such as instructions to perform any of the methods 200, 400, and/or 500 of FIGS. 2, 4, and 5, respectively. For example, the processor 710 may identify variables corresponding to an optimization problem, assign one or more binary nodes to each variable, calculate objective function values, determine one or more candidate solutions to the optimization problem using a surrogate QUBO model, and/or determine a solution to the optimization problem based on the one or more candidate solutions.

The memory 720 and the data storage 730 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 710. For example, the memory 720 and/or the data storage 730 may store obtained variables (such as the variables 110, first binary nodes 112, and/or second binary nodes 114 in FIG. 1). In some embodiments, the computing system 700 may or may not include either of the memory 720 and the data storage 730.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 710 to perform a certain operation or group of operations.

The communication unit 740 may include any component, device, system, or combination thereof that is configured to transmit or receive information over a network. In some embodiments, the communication unit 740 may communicate with other devices at other locations, the same location, or even other components within the same system. For example, the communication unit 740 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 740 may permit data to be exchanged with a network and/or any other devices or systems described in the present disclosure. For example, the communication unit 740 may allow the system 700 to communicate with other systems, such as computing devices and/or other networks.

One skilled in the art, after reviewing this disclosure, may recognize that modifications, additions, or omissions may be made to the system 700 without departing from the scope of the present disclosure. For example, the system 700 may include more or fewer components than those explicitly illustrated and described.

The embodiments described in the present disclosure may include the use of a special purpose or general-purpose computer including various computer hardware or software modules. Further, embodiments described in the present disclosure may be implemented using computer-readable media for carrying or having computer-executable instructions or data structures stored thereon.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A method, comprising:
identifying a plurality of variables corresponding to an optimization problem, each variable of the plurality of variables having a corresponding initial value;
calculating an objective function value based on the initial values of the plurality of variables;
calculating a plurality of function value changes of the objective function value, wherein each function value change of the plurality of function value changes is calculated based on a different one of a plurality of variable value changes and each of the variable value changes corresponds to a respective change made to a different one of the initial values;
selecting a subset of the variables based on the respective function value changes that correspond to corresponding variable value changes made to the respective initial values of the variables of the subset of variables;
generating a surrogate quadratic unconstrained binary optimization (QUBO) model of the optimization problem using the selected subset of variables;
determining one or more candidate solutions to the optimization problem using the surrogate QUBO model, each of the one or more candidate solutions comprising a set of solution values and each of the solution values of the set of solution values corresponding to a different variable of the plurality of variables; and
determining a solution to the optimization problem based on the one or more candidate solutions.

2. The method of claim 1, further comprising:
determining an updated value associated with each variable based on the solution to the optimization problem and the corresponding initial value of each variable;
selecting a second subset of the variables based on the updated values;
determining one or more second candidate solutions to the optimization problem using the surrogate QUBO model based on the second subset of the variables; and
determining a second solution to the optimization problem based on the one or more second candidate solutions.

3. The method of claim 1, wherein calculating the plurality of function value changes of the objective function value based on the variable value change comprises:
assigning one or more binary nodes to each variable, each binary node having a binary value, wherein the binary value indicates a change in the initial value of the variable associated with the binary value;
flipping one or more binary values corresponding to the binary nodes associated with one or more of the variables;
calculating the variable value change based on the initial value of the variable and the one or more flipped binary values; and
calculating a function value change of the plurality based on the variable value change.

4. The method of claim 1, wherein each variable value change of the plurality of variable value changes corresponds to a same change made to a different one of the initial values and selecting the subset of the variables comprises:
calculating the plurality of function value changes of the objective function value based on the variable value change made to the different one of the initial values;
sorting the variables based on the function value change and the respective change made to the initial value of each of the variables; and
selecting the subset of the variables based on the sorting.

5. The method of claim 1, wherein determining the one or more candidate solutions to the optimization problem using the surrogate QUBO model comprises:
determining a constraint associated with at least one variable or the objective function value, the constraint indicating a limit corresponding to a value of the at least one variable or a limit corresponding to the objective function value;
comparing the set of solution values corresponding to the plurality of variables of a particular candidate solution to the constraint;
calculating a penalty value based on the comparing the set of solution values corresponding to the plurality of variables of the candidate solution to the constraint, the penalty value indicating a degree of difference between the set of solution values and the constraint;
calculating a penalty score associated with the candidate solution based on the penalty value; and
determining a solution to the optimization problem based on one or more penalty scores each associated with a particular candidate solution.

6. The method of claim 1, wherein the optimization problem includes determining a prescribed radiation dosage to be delivered to a tumor and one or more organs using Intensity-Modulated Radiation Therapy.

7. The method of claim 6, wherein the plurality of variables corresponding to the optimization problem is a dosage received in a voxel of a specified tissue volume of the tumor and the organs.

8. One or more non-transitory computer-readable storage media configured to store instructions that, in response to being executed, cause a system to perform operations, the operations comprising:
identifying a plurality of variables corresponding to an optimization problem, each variable of the plurality of variables having a corresponding initial value;
calculating an objective function value based on the initial values of the plurality of variables;
calculating a plurality of function value changes of the objective function value, wherein each function value change of the plurality of function value changes is calculated based on a different one of a plurality of variable value changes and each of the variable value changes corresponds to a respective change made to a different one of the initial values;
selecting a subset of the variables based on the respective function value changes that correspond to corresponding variable value changes made to the respective initial values of the variables of the subset of variables;
generating a surrogate quadratic unconstrained binary optimization (QUBO) model of the optimization problem using the selected subset of variables;
determining one or more candidate solutions to the optimization problem using the surrogate QUBO model, each of the one or more candidate solutions comprising a set of solution values and each of the solution values of the set of solution values corresponding to a different variable of the plurality of variables; and
determining a solution to the optimization problem based on the one or more candidate solutions.

9. The one or more non-transitory computer-readable storage media of claim 8, the operations further comprising:
determining an updated value associated with each variable based on the solution to the optimization problem and the corresponding initial value of each variable;
selecting a second subset of the variables based on the updated values;
determining one or more second candidate solutions to the optimization problem using the surrogate QUBO model based on the second subset of the variables; and
determining a second solution to the optimization problem based on the one or more second candidate solutions.

10. The one or more non-transitory computer-readable storage media of claim 8, wherein calculating the plurality of function value changes of the objective function value based on the variable value change comprises:
assigning one or more binary nodes to each variable, each binary node having a binary value, wherein the binary value indicates a change in the initial value of the variable associated with the binary value;
flipping one or more binary values corresponding to the binary nodes associated with one or more of the variables;
calculating the variable value change based on the initial value of the variable and the one or more flipped binary values; and
calculating a function value change of the plurality based on the variable value change.

11. The one or more non-transitory computer-readable storage media of claim 8, wherein each variable value change of the plurality of variable value changes corresponds to a same change made to a different one of the initial values and selecting the subset of the variables comprises:
calculating the plurality of function value changes of the objective function value based on the variable value change made to the different one of the initial values;
sorting the variables based on the function value change and the respective change made to the initial value of each of the variables; and
selecting the subset of the variables based on the sorting.

12. The one or more non-transitory computer-readable storage media of claim 8, wherein determining the one or more candidate solutions to the optimization problem using the surrogate QUBO model comprises:
determining a constraint associated with at least one variable or the objective function value, the constraint indicating a limit corresponding to a value of the at least one variable or a limit corresponding to the objective function value;
comparing the set of solution values corresponding to the plurality of variables of a particular candidate solution to the constraint;
calculating a penalty value based on the comparing the set of solution values corresponding to the plurality of variables of the candidate solution to the constraint, the penalty value indicating a degree of difference between the set of solution values and the constraint;
calculating a penalty score associated with the candidate solution based on the penalty value; and
determining a solution to the optimization problem based on one or more penalty scores each associated with a particular candidate solution.

13. The one or more non-transitory computer-readable storage media of claim 8, wherein the optimization problem includes determining a prescribed radiation dosage to be delivered to a tumor and one or more organs using Intensity-Modulated Radiation Therapy.

14. The one or more non-transitory computer-readable storage media of claim 8, wherein the plurality of variables corresponding to the optimization problem is a dosage received in a voxel of a specified tissue volume of the tumor and the organs.

15. A system comprising:
one or more processors; and
one or more non-transitory computer-readable storage media configured to store instructions that, in response to being executed, cause the system to perform operations, the operations comprising:
identifying a plurality of variables corresponding to an optimization problem, each variable of the plurality of variables having a corresponding initial value;
calculating an objective function value based on the initial values of the plurality of variables;
calculating a plurality of function value changes of the objective function value, wherein each function value change of the plurality of function value changes is calculated based on a different one of a plurality of variable value changes and each of the variable value changes corresponds to a respective change made to a different one of the initial values;
selecting a subset of the variables based on the respective function value changes that correspond to corresponding variable value changes made to the respective initial values of the variables of the subset of variables;
generating a surrogate quadratic unconstrained binary optimization (QUBO) model of the optimization problem using the selected subset of variables;
determining one or more candidate solutions to the optimization problem using the surrogate QUBO model, each of the one or more candidate solutions comprising a set of solution values and each of the solution values of the set of solution values corresponding to a different variable of the plurality of variables; and
determining a solution to the optimization problem based on the one or more candidate solutions.

16. The system of claim 15, the operations further comprising:
determining an updated value associated with each variable based on the solution to the optimization problem and the corresponding initial value of each variable;
selecting a second subset of the variables based on the updated values;
determining one or more second candidate solutions to the optimization problem using the surrogate QUBO model based on the second subset of the variables; and
determining a second solution to the optimization problem based on the one or more second candidate solutions.

17. The system of claim 15, wherein calculating the plurality of function value changes of the objective function value based on the variable value change comprises:
assigning one or more binary nodes to each variable, each binary node having a binary value, wherein the binary value indicates a change in the initial value of the variable associated with the binary value;
flipping one or more binary values corresponding to the binary nodes associated with one or more of the variables;
calculating the variable value change based on the initial value of the variable and the one or more flipped binary values; and
calculating a function value change of the plurality based on the variable value change.

18. The system of claim 15, wherein each variable value change of the plurality of variable value changes corresponds to a same change made to a different one of the initial values and selecting the subset of the variables comprises:
calculating the plurality of function value changes of the objective function value based on the variable value change made to the different one of the initial values;
sorting the variables based on the function value change and the respective change made to the initial value of each of the variables; and
selecting the subset of the variables based on the sorting.

19. The system of claim 15, wherein determining the one or more candidate solutions to the optimization problem using the surrogate QUBO model comprises:
determining a constraint associated with at least one variable or the objective function value, the constraint indicating a limit corresponding to a value of the at least one variable or a limit corresponding to the objective function value;
comparing the set of solution values corresponding to the plurality of variables of a particular candidate solution to the constraint;
calculating a penalty value based on the comparing the set of solution values corresponding to the plurality of variables of the candidate solution to the constraint, the penalty value indicating a degree of difference between the set of solution values and the constraint;
calculating a penalty score associated with the candidate solution based on the penalty value; and
determining a solution to the optimization problem based on one or more penalty scores each associated with a particular candidate solution.

20. The system of claim 15, wherein the optimization problem includes determining a prescribed radiation dosage to be delivered to a tumor and one or more organs using Intensity-Modulated Radiation Therapy.
